(19) United States
(12) Patent Application Publication
(10) Pub. No.: US 2016/0147103 A1
(43) Pub. Date: May 26, 2016

(54) DISPLAY PANEL AND DISPLAY DEVICE

(71) Applicant: Shenzhen China Star Optoelectronics Technology Co. Ltd., Shenzhen (CN)

(72) Inventor: Shishuai HUANG, Shenzhen (CN)

(73) Assignee: Shenzhen China Star Optoelectronics Technology Co. Ltd., Shenzhen (CN)

(21) Appl. No.: 14/417,152

(22) PCT Filed: Nov. 28, 2014
(86) PCT No.: PCT/CN2014/092561

§ 371 Date: Jan. 25, 2015

(30) Foreign Application Priority Data
Nov. 24, 2014 (CN) 201410680186.X

(51) Int. Cl. G02F 1/1339; G02F 1/1335; G02F 1/1368

(52) U.S. Cl. CPC G02F 1/13394; G02F 1/1368; G02F 1/1339; G02F 1/133514; G02F 2001/13396; G02F 2001/133388

(57) ABSTRACT

A display panel and a display device are provided. The display panel comprises a color filter substrate, a thin film transistor array substrate, a liquid crystal layer, a sealing component, and a space holding member. The space holding member is used to keep a first interval value of a liquid crystal cell in a predetermined range. The predetermined range is from (1-5%)*a second interval value to (1+5%)*the second interval value, wherein the second interval value is a distance in a display area of the liquid crystal cell. It can prevent a phenomenon of light spots.

### FIELD OF THE INVENTION

The present invention relates to a technical field of displays, and more particularly to a display panel and a display device.

### BACKGROUND OF THE INVENTION

A traditional display panel is generally provided with sealant. The sealant is disposed on the edges of the display panel, and the effect thereof is sealing the display panel, so as to prevent liquid crystal molecules from leaking.

A traditional sealant is generally provided with spacers. The materials of the spacers are mainly Melamine resin, Polystyrene resin, etc. Since the compression ratios of the materials are greater than the compression ratio of photo spacer in an active area, meaning the sealant is more compressed in the corresponding area, the liquid crystal cell gap of the area of the sealant is smaller than the liquid crystal cell gap of the display area, which causes a phenomenon of light spots.

Hence, it is necessary to provide a new technical solution to solve the above-mentioned problem.

### SUMMARY OF THE INVENTION

An object of the present invention is to provide a display panel and a display device which can prevent the periphery of a sealing component from forming light spots.

For solving the above-mentioned technical problems, the present invention provides technical solutions which are as follows:

A display panel is provided, which comprises: a color filter substrate; a thin film transistor array substrate, wherein the thin film transistor array substrate and the color filter substrate are stacked and combined in to one piece; a liquid crystal layer disposed between the thin film transistor array substrate and the color filter substrate; a sealing component, wherein the sealing component is clamped between the thin film transistor array substrate and the color filter substrate; the sealing component encloses the liquid crystal layer; the sealing component is used to seal a liquid crystal cell which is assembled by the thin film transistor array substrate and the color filter substrate; and the sealing component is disposed on a non-display area of the liquid crystal cell; and a space holding member, wherein the space holding member is disposed between the thin film transistor array substrate and the color filter substrate; the space holding member is placed on the non-display area; the space holding member is used to keep a first interval value of the liquid crystal cell in a predetermined range; the first interval value is a distance between the thin film transistor array substrate and the color filter substrate in the non-display area; the second interval value is a distance between the thin film transistor array substrate and the color filter substrate in a display area of the liquid crystal cell; the predetermined range is from (1-5%)*the second interval value to (1+5%)*the second interval value; and the non-display area is disposed on the outside of the display area; wherein the first interval value is equal to the second interval value; the sealing component comprises at least four sealing segments, and the at least four sealing segments are connected end to end, so as to form as a sealing frame; the space holding member comprises at least one supporting block; the supporting block is disposed inside the sealing segment, and the sealing segment and the supporting block are fixed to each other.

In the above-mentioned display panel, the sealing segment comprises at least one grid, and the supporting block is disposed inside the grid.

A display panel is provided, which comprises: a color filter substrate; a thin film transistor array substrate, wherein the thin film transistor array substrate and the color filter substrate are stacked and combined into one piece; a liquid crystal layer disposed between the thin film transistor array substrate and the color filter substrate; a sealing component, wherein the sealing component is clamped between the thin film transistor array substrate and the color filter substrate; the sealing component encloses the liquid crystal layer; the sealing component is used to seal a liquid crystal cell which is assembled by the thin film transistor array substrate and the color filter substrate; and the sealing component is disposed on a non-display area of the liquid crystal cell; and a space holding member, wherein the space holding member is disposed between the thin film transistor array substrate and the color filter substrate; the space holding member is placed on the non-display area; the space holding member is used to keep a first interval value of the liquid crystal cell in a predetermined range; the first interval value is a distance between the thin film transistor array substrate and the color filter substrate in the non-display area; the second interval value is a distance between the thin film transistor array substrate and the color filter substrate in a display area of the liquid crystal cell; the predetermined range is from (1-5%)*the second interval value to (1+5%)*the second interval value; and the non-display area is disposed on the outside of the display area.

In the above-mentioned display panel, the first interval value is equal to the second interval value.

In the above-mentioned display panel, the sealing component comprises at least four sealing segments, and the at least four sealing segments are connected end to end, so as to form as a sealing frame. The space holding member comprises at least one supporting block; the supporting block is disposed inside the sealing segment, and the sealing segment and the supporting block are fixed to each other.

In the above-mentioned display panel, the sealing segment comprises at least one grid, and the supporting block is disposed inside the grid.

In the above-mentioned display panel, the sealing segment comprises at least one sealing rib, and the supporting block is disposed on the sealing rib.

In the above-mentioned display panel, an inside of the supporting block is provided with a conductive post. The conductive post passes through the supporting block, and further passes through a protecting layer of the thin film transistor array substrate. The conductive post is connected with a common electrode of the color filter substrate and a common line of the thin film transistor array substrate.

In the above-mentioned display panel, the conductive post is formed by providing a through hole in the supporting block and filling a conductive material into the through hole; the through hole passes through the common line of the thin film transistor array substrate.

In the above-mentioned display panel, an inside of the supporting block is provided with solid particles. The inside of the supporting block is spread with the solid particles, and the solid particles are used to increase the structural strength of the supporting block. The solid particles are metal particles or glass particles.

In the above-mentioned display panel, an inside of the supporting block is provided with metal ribs; the inside of the supporting block is spread with the metal ribs. The metal ribs are used to increase the structural strength of the supporting block, and the metal ribs are metal wires.

A display device is provided, which comprises: a backlight module; and a display panel, wherein the display panel and the backlight module are stacked and combined into one piece; and the display panel comprises: a color filter substrate; a thin film transistor array substrate, wherein the thin film transistor array substrate and the color filter substrate are stacked and combined into one piece; a liquid crystal layer disposed between the thin film transistor array substrate and the color filter substrate; a sealing component, wherein the sealing component is clamped between the thin film transistor array substrate and the color filter substrate; the sealing component encloses the liquid crystal layer; the sealing component is used to seal a liquid crystal cell which is assembled by the thin film transistor array substrate and the color filter substrate; and the sealing component is disposed on a non-display area of the liquid crystal cell; and a space holding member, wherein the space holding member is disposed between the thin film transistor array substrate and the color filter substrate; the space holding member is placed on the non-display area; the space holding member is used to keep a first interval value of the liquid crystal cell in a predetermined range; the first interval value is a distance between the thin film transistor array substrate and the color filter substrate in the non-display area; the second interval value is a distance between the thin film transistor array substrate and the color filter substrate in a display area of the liquid crystal cell; the predetermined range is from (1-5%)*the second interval value to (1+5%)*the second interval value; and the non-display area is disposed on the outside of the display area.

In the above-mentioned display device, the first interval value is equal to the second interval value.

In the above-mentioned display device, the sealing component comprises at least four sealing segments, and the at least four sealing segments are connected end to end, so as to form as a sealing frame. The space holding member comprises at least one supporting block, and the supporting block is disposed inside the sealing segment. The sealing segment and the supporting block are fixed to each other.

In the above-mentioned display device, the sealing segment comprises at least one grid, and the supporting block is disposed inside the grid.

In the above-mentioned display device, the sealing segment comprises at least one sealing rib, and the supporting block is disposed on the sealing rib.

In the above-mentioned display device, an inside of the supporting block is provided with a conductive post. The conductive post passes through the supporting block, and further passes through a protecting layer of the thin film transistor array substrate. The conductive post is connected with a common electrode of the color filter substrate and a common line of the thin film transistor array substrate.

In the above-mentioned display device, the conductive post is formed by providing a through hole in the supporting block and filling a conductive material into the through hole; the through hole passes through the common line of the thin film transistor array substrate.

In the above-mentioned display device, an inside of the supporting block is provided with solid particles; the inside of the supporting block is spread with the solid particles. The solid particles are used to increase the structural strength of the supporting block, and the solid particles are metal particles or glass particles.

In the above-mentioned display device, an inside of the supporting block is provided with metal ribs; the inside of the supporting block is spread with the metal ribs. The metal ribs are used to increase the structural strength of the supporting block, and the metal ribs are metal wires.

Compared to traditional technologies, the present invention can decrease the difference between the width of the liquid crystal cell gap of the non-display area and the width of the liquid crystal cell gap of the display area, so that it is advantageous to prevent the periphery of the sealing component from forming light spots.

The above-mention contents of the present invention can be best understood by referring to the following detailed description of the preferred embodiments and the accompanying drawings.

### DESCRIPTION OF THE DRAWINGS

FIG. 1 is a schematic view of a display device of the present invention;

FIG. 2 is a schematic view of a display panel in FIG. 1;

FIG. 3 is a schematic view of area A of a first embodiment in FIG. 2;

FIG. 4 is a schematic view of a cross-section B-B′ in FIG. 3; and

FIG. 5 is a schematic view of area A of a second embodiment in FIG. 2.

### DETAILED DESCRIPTION OF THE PREFERRED EMBODIMENTS

In this specification, “an embodiment” means serving as an example, instance, or illustration. Moreover, in this specification and the appended claims the article “a” may generally be construed to mean “one or more” unless specified otherwise or clear from the context to be guided towards the singular form.

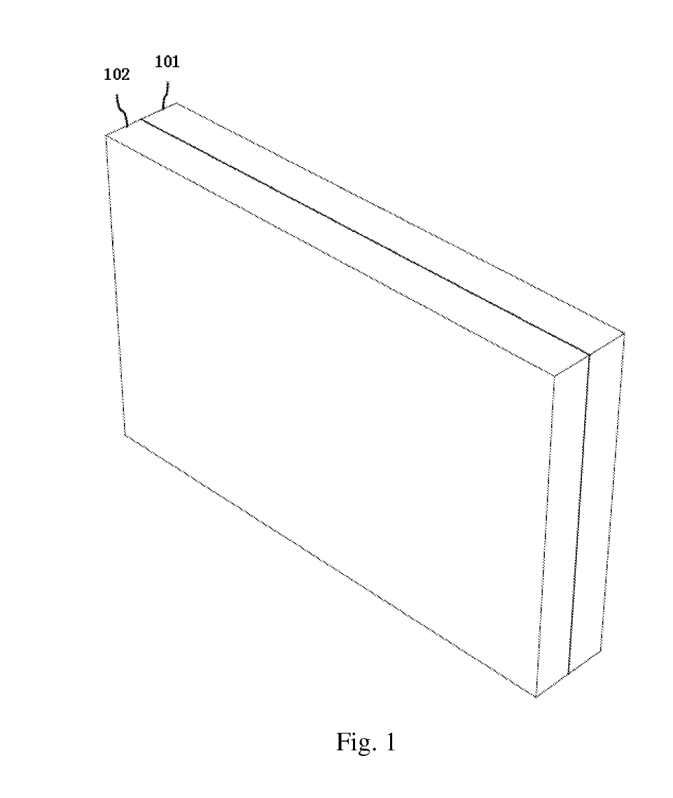

Refer now to FIG. 1, which is a schematic view of a display device of the present invention.

A display device of the present invention comprises a backlight module 101 and a display panel 102, wherein the display panel 102 and the backlight module 101 are stacked and combined into one piece. The display panel 102 of the present invention is, for example, a TFT-LCD (thin film transistor liquid crystal display).

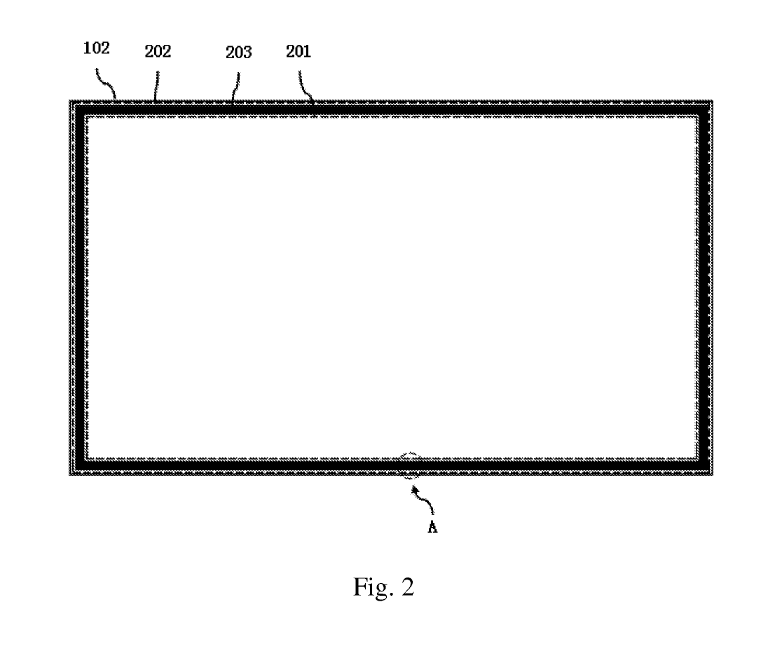

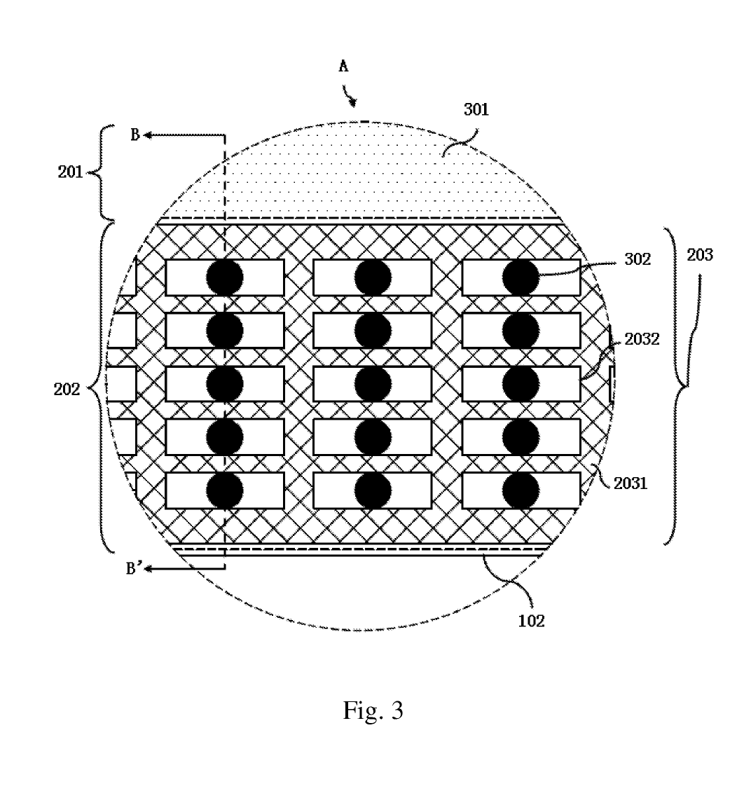

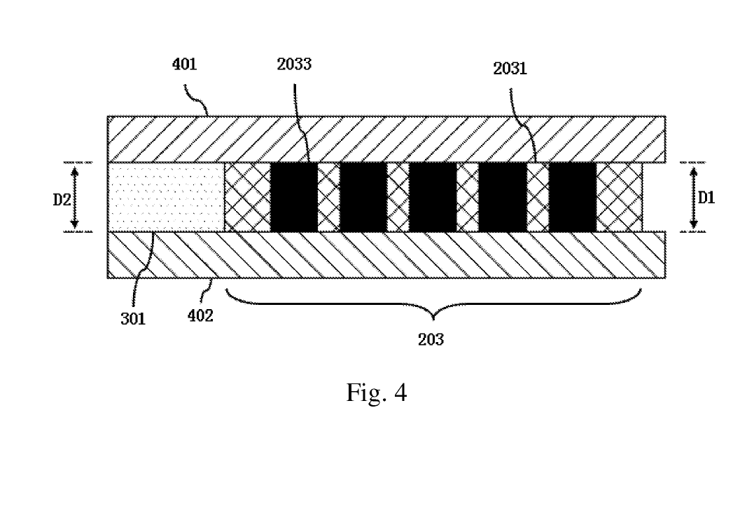

Refer now to FIG. 2, FIG. 3, and FIG. 4, wherein FIG. 2 is a schematic view of a display panel in FIG. 1; FIG. 3 is a schematic view of area A of a first embodiment in FIG. 2; and FIG. 4 is a schematic view of a cross-section B-B′ in FIG. 3.

The display panel 102 of the present invention comprises a color filter substrate 401, a thin film transistor array substrate 402, a liquid crystal layer 301, a sealing component 203, and a space holding member.

The thin film transistor array substrate 402 and the color filter substrate 401 are stacked and combined into one piece. The liquid crystal layer 301 is disposed between the thin film transistor array substrate 402 and the color filter substrate 401, and the sealing component 203 is clamped between the thin film transistor array substrate 402 and the color filter substrate 401. The sealing component 203 is disposed as a rectangle, and the sealing component 203 encloses the liquid crystal layer 301. That is, the sealing component 203 is used to seal a liquid crystal cell which is assembled by the thin film transistor array substrate 402 and the color filter substrate 401.

The liquid crystal cell comprises a display area 201 and a non-display area 202, wherein the non-display area 202 is disposed on the outside of the display area 201, and the sealing component 203 is disposed on the non-display area 202. The non-display area 202 encloses the display area 201.

The space holding member is disposed between the thin film transistor array substrate 402 and the color filter substrate 401, and the space holding member is placed on the non-display area 202. The space holding member is used to keep a first interval value D1 of the liquid crystal cell in a predetermined range. The first interval value D1 is a distance between the thin film transistor array substrate 402 and the color filter substrate 401 in the non-display area 202, and the second interval value D2 is a distance between the thin film transistor array substrate 402 and the color filter substrate 401 in the display area 201. The predetermined range is from (1-5%)*the second interval value D2 to (1+5%)*the second interval value D2. The non-display area 202 is disposed on the outside of the display area 201. Preferably, the first interval value D1 is equal to the second interval value D2.

The space holding member is used together with the sealing component 203 to support the thin film transistor array substrate 402 and the color filter substrate 401, and used to seal the liquid crystal cell.

In the embodiment, the sealing component 203 comprises at least four sealing segments 2031, and the at least four sealing segments 2031 are connected end to end, so as to form as a sealing frame. The sealing segment 2031 comprises at least one grid 2032.

The space holding member comprises at least one supporting block 302. The supporting block 302 is disposed inside the sealing segment 2031, and the sealing segment 2031 and the supporting block 302 are fixed to each other. The supporting block 302 is disposed into the grid 2032. Preferably, the grid 2032 is filled with the supporting block 302.

In the embodiment, the width of the sealing segment 2031 is in a range of 200 micrometers to 4000 micrometers.

In the embodiment, the sealing segment 2031 is provided with a through hole. The through hole passes through the sealing segment 2031 and a protecting layer on the thin film transistor array substrate 402 in a first direction. The first direction is a direction which is perpendicular to the color filter substrate 401. The side wall of the through hole is provided with a conductive layer, and the conductive layer is connected to a common electrode of the color filter substrate 401 and a common line of the thin film transistor array substrate 402.

In the embodiment, the space holding member and a photo spacer in the display area 201 are formed in the same process. That is, the space holding member is formed in the process of forming the photo spacer.

Furthermore, in the sealing segment 2031, there are at least two of the supporting blocks 302 which are connected to each other. This is advantageous to increasing the total structural strength of an array which is combined with the at least two supporting block 302, so as to improve the anti-compression ability of the space holding member.

In the above-mentioned technical solution, because the sealing segment 2031 is provided with the space holding member, which is used to support the thin film transistor array substrate 402 and the color filter substrate 401, and the anti-compression ability of the space holding member is better than the anti-compression ability of the traditional spacer, it is advantageous to decrease the difference between the width of the liquid crystal cell gap of the area corresponding to the sealing segment 2031 (the non-display area 202) and the width of the liquid crystal cell gap of the display area 201, and it is advantageous to prevent the periphery of the sealing component 203 (the non-display area 202) from a phenomenon of light spots.

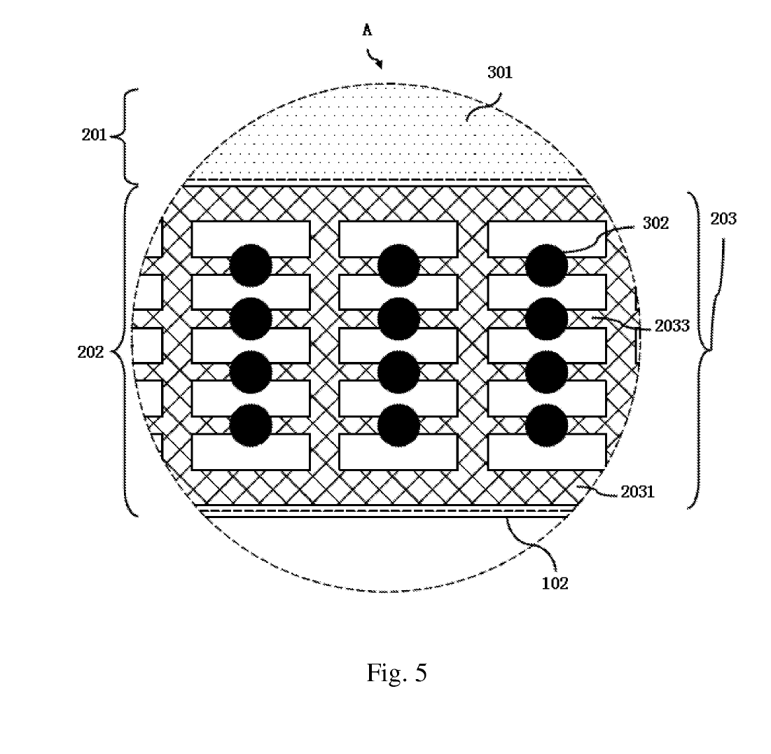

Refer now to FIG. 5, which is a schematic view of area A of a second embodiment in FIG. 2. This embodiment is similar to the above-mentioned first embodiment, but the difference therebetween is that:

the sealing segment 2031 comprises at least one sealing rib 2033, and the supporting block 302 is disposed on the sealing rib 2033. That is, the sealing rib 2033 is connected with the supporting block 302, and the supporting block 302 is fixed by the sealing rib 2033.

Additionally, two of the adjoining supporting blocks 302 are serially connected to each other.

A third embodiment is similar to the above-mentioned first or second embodiment, but the difference therebetween is that:

an inside of the supporting block 302 is provided with solid particles and/or metal ribs; the inside of the supporting block 302 is spread with the solid particles and/or the metal ribs; and the solid particles and/or the metal ribs are used to increase the structural strength of the supporting block 302, so as to decrease deformation of the supporting block 302 as far as possible when the thin film transistor array substrate 402 and the color filter substrate 401 are compressed. This is advantageous to keeping the first interval value D1 in the predetermined range.

Preferably, the solid particles are metal particles or glass particles, and the metal ribs are metal wires.

A fourth embodiment is similar to the above-mentioned first or second embodiment, but the difference therebetween is that:

an inside of the supporting block 302 is provided with a conductive post, and the conductive post passes through the protecting layer of the thin film transistor array substrate 402. The conductive post is connected with a common electrode of the color filter substrate 401 and a common line of the thin film transistor array substrate 402.

The conductive post is formed by providing a through hole in the supporting block 302 and filling a conductive material into the through hole, wherein the through hole passes through the common line of the thin film transistor array substrate 402.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

The present invention has been described with preferred embodiments thereof and it is understood that many changes and modifications to the described embodiments can be carried out without departing from the scope and the spirit of the invention that is intended to be limited only by the appended claims.

1. A display panel, comprising:
a color filter substrate;
a thin film transistor array substrate, wherein the thin film transistor array substrate and the color filter substrate are stacked and combined into one piece;
a liquid crystal layer disposed between the thin film transistor array substrate and the color filter substrate;
a sealing component, wherein the sealing component is clamped between the thin film transistor array substrate and the color filter substrate; the sealing component encloses the liquid crystal layer; the sealing component is used to seal a liquid crystal cell which is assembled by the thin film transistor array substrate and the color filter substrate; and the sealing component is disposed on a non-display area of the liquid crystal cell; and
a space holding member, wherein the space holding member is disposed between the thin film transistor array substrate and the color filter substrate; the space holding member is placed on the non-display area; the space holding member is used to keep a first interval value of the liquid crystal cell in a predetermined range; the first interval value is a distance between the thin film transistor array substrate and the color filter substrate in the non-display area; the second interval value is a distance between the thin film transistor array substrate and the color filter substrate in a display area of the liquid crystal cell; the predetermined range is from (1-5%)*the second interval value to (1+5%)*the second interval value; and the non-display area is disposed on the outside of the display area;
wherein the first interval value is equal to the second interval value;
the sealing component comprises at least four sealing segments, and the at least four sealing segments are connected end to end, so as to form as a sealing frame;
the space holding member comprises at least one supporting block; and
the supporting block is disposed inside the sealing segment, and the sealing segment and the supporting block are fixed to each other.

2. The display panel according to claim 1, wherein the sealing segment comprises at least one grid, and the supporting block is disposed inside the grid.

3. A display panel, comprising:
a color filter substrate;
a thin film transistor array substrate, wherein the thin film transistor array substrate and the color filter substrate are stacked and combined into one piece;
a liquid crystal layer disposed between the thin film transistor array substrate and the color filter substrate;
a sealing component, wherein the sealing component is clamped between the thin film transistor array substrate and the color filter substrate; the sealing component encloses the liquid crystal layer; the sealing component is used to seal a liquid crystal cell which is assembled by the thin film transistor array substrate and the color filter substrate; and the sealing component is disposed on a non-display area of the liquid crystal cell; and
a space holding member, wherein the space holding member is disposed between the thin film transistor array substrate and the color filter substrate; the space holding member is placed on the non-display area; the space holding member is used to keep a first interval value of the liquid crystal cell in a predetermined range; the first interval value is a distance between the thin film transistor array substrate and the color filter substrate in the non-display area; the second interval value is a distance between the thin film transistor array substrate and the color filter substrate in a display area of the liquid crystal cell; the predetermined range is from (1-5%)*the second interval value to (1+5%)*the second interval value; and the non-display area is disposed on the outside of the display area.

4. The display panel according to claim 3, wherein the first interval value is equal to the second interval value.

5. The display panel according to claim 3, wherein the sealing component comprises at least four sealing segments, and the at least four sealing segments are connected end to end, so as to form as a sealing frame;
the space holding member comprises at least one supporting block; and
the supporting block is disposed inside the sealing segment, and the sealing segment and the supporting block are fixed to each other.

6. The display panel according to claim 5, wherein the sealing segment comprises at least one grid, and the supporting block is disposed inside the grid.

7. The display panel according to claim 5, wherein the sealing segment comprises at least one sealing rib, and the supporting block is disposed on the sealing rib.

8. The display panel according to claim 5, wherein an inside of the supporting block is provided with a conductive post; the conductive post passes through the supporting block; the conductive post further passes through a protecting layer of the thin film transistor array substrate; and the conductive post is connected with a common electrode of the color filter substrate and a common line of the thin film transistor array substrate.

9. The display panel according to claim 8, wherein the conductive post is formed by providing a through hole in the supporting block and filling a conductive material into the through hole; and the through hole passes through the common line of the thin film transistor array substrate.

10. The display panel according to claim 5, wherein an inside of the supporting block is provided with solid particles; the inside of the supporting block is spread with the solid particles; and the solid particles are used to increase the structural strength of the supporting block; and
the solid particles are metal particles or glass particles.

11. The display panel according to claim 5, wherein an inside of the supporting block is provided with metal ribs; the inside of the supporting block is spread with the metal ribs; the metal ribs are used to increase the structural strength of the supporting block; and
the metal ribs are metal wires.

12. A display device, comprising:
a backlight module; and
a display panel, wherein the display panel and the backlight module are stacked and combined into one piece; and the display panel comprises:
a color filter substrate;
a thin film transistor array substrate, wherein the thin film transistor array substrate and the color filter substrate are stacked and combined into one piece;
a liquid crystal layer disposed between the thin film transistor array substrate and the color filter substrate;
a sealing component, wherein the sealing component is clamped between the thin film transistor array substrate and the color filter substrate; the sealing component encloses the liquid crystal layer; the sealing component is used to seal a liquid crystal cell which is assembled by the thin film transistor array substrate and the color filter substrate; and the sealing component is disposed on a non-display area of the liquid crystal cell; and
a space holding member, wherein the space holding member is disposed between the thin film transistor array substrate and the color filter substrate; the space holding member is placed on the non-display area; the space holding member is used to keep a first interval value of the liquid crystal cell in a predetermined range; the first interval value is a distance between the thin film transistor array substrate and the color filter substrate in the non-display area; the second interval value is a distance between the thin film transistor array substrate and the color filter substrate in a display area of the liquid crystal cell; the predetermined range is from (1-5%)*the second interval value to (1+5%)*the second interval value; and the non-display area is disposed on the outside of the display area.

13. The display device according to claim 12, wherein the first interval value is equal to the second interval value.

14. The display device according to claim 12, wherein the sealing component comprises at least four sealing segments, and the at least four sealing segments are connected end to end, so as to form as a sealing frame;
the space holding member comprises at least one supporting block; and
the supporting block is disposed inside the sealing segment, and the sealing segment and the supporting block are fixed to each other.

15. The display device according to claim 14, wherein the sealing segment comprises at least one grid, and the supporting block is disposed inside the grid.

16. The display device according to claim 14, wherein the sealing segment comprises at least one sealing rib, and the supporting block is disposed on the sealing rib.

17. The display device according to claim 16, wherein an inside of the supporting block is provided with a conductive post; the conductive post passes through the supporting block; the conductive post further passes through a protecting layer of the thin film transistor array substrate; and the conductive post is connected with a common electrode of the color filter substrate and a common line of the thin film transistor array substrate.

18. The display device according to claim 17, wherein the conductive post is formed by providing a through hole in the supporting block and filling a conductive material into the through hole; and the through hole passes through the common line of the thin film transistor array substrate.

19. The display device according to claim 14, wherein an inside of the supporting block is provided with solid particles; the inside of the supporting block is spread with the solid particles; and the solid particles are used to increase the structural strength of the supporting block; and
the solid particles are metal particles or glass particles.

20. The display device according to claim 14, wherein an inside of the supporting block is provided with metal ribs; the inside of the supporting block is spread with the metal ribs; the metal ribs are used to increase the structural strength of the supporting block; and
the metal ribs are metal wires.
